(19) United States
(12) Patent Application Publication
(10) Pub. No.: US 2025/0161844 A1
(43) Pub. Date: May 22, 2025

(54) GAS SEPARATION DEVICE

(71) Applicant: W. L. Gore & Associates, Inc., Newark, DE (US)

(72) Inventors: Michael C. McManaway, Cecilton, MD (US); Hasan Hashemisohi, Newark, DE (US); Kenneth S. Zukor, Havre de Grace, MD (US)

(73) Assignee: W. L. Gore & Associates, Inc., Newark, DE (US)

(21) Appl. No.: 18/839,618

(22) PCT Filed: Mar. 10, 2023
(86) PCT No.: PCT/US23/14960

§ 371 Date: Aug. 19, 2024

Related U.S. Application Data
(60) Provisional application No. 63/319,180, filed on Mar. 11, 2022.

(51) Int. Cl. B01D 19/00; B01D 15/12

(52) U.S. Cl. CPC B01D 19/0031; B01D 15/125

(57) ABSTRACT

A gas separation device for use in combination with a liquid chromatography system is provided. The gas separation device includes a housing defining a fluid flow path between an outer surface and an inner surface. The fluid flow path includes an inlet portion, a diffuser portion, a recombination portion, and an outlet portion. Any gas bubbles contained within the fluid are trapped within the diffusor portion when fluid flow is in a forward direction. Fluid flow through the gas separation device is reversable so as to remove the trapped gas bubbles from within the gas separation device. In this operation state, the fluid is delivered from the gas separation device into the waste stream to ensure that gas bubbles leave the liquid chromatography system. The gas separation device may exhibit an air trapping effectiveness ratio (ATER) between 0.001 mb⁻¹ and 0.51 mb⁻¹ during forward direction fluid flow.

### FIELD

The present disclosure relates generally to gas separation devices and methods, and more specifically, to gas separation devices and methods for use with a liquid chromatography system.

### BACKGROUND

Liquid chromatographic methods generally are used to separate and/or purify molecules of interest such as proteins, nucleic acids, and polysaccharides from a fluid mixture. For example, affinity chromatography specifically involves passing the fluid mixture over a matrix having a ligand specific (i.e., a specific binding partner) for the molecule of interest bound to it. Upon contacting the ligand, the molecule of interest is bound to the matrix and is therefore removed from the fluid mixture.

During delivery of fluids containing molecules of interest, as well as other fluids for use in the chromatography devices, gas bubbles may be introduced into the system. It is generally disadvantageous to the function of the liquid chromatography device when gas bubbles are introduced into the system and is desirable to reduce these instances.

### SUMMARY

In a first example (“Example 1”), a gas separation device includes a housing defining a fluid flow path between an outer surface and an inner surface, the housing having an inlet in communication with the fluid flow path and an outlet in communication with the fluid flow path, the housing being operable to permit fluid flow in a forward direction from the inlet to the outlet and in a reverse direction from the outlet to the inlet. The fluid flow path defines a fluid path volume and includes an inlet portion arranged to receive fluid from the inlet during fluid flow in the forward direction through the housing, the inlet portion defining an inlet portion volume, a diffuser portion arranged to receive fluid from the inlet portion during fluid flow in the forward direction through the housing, the diffuser portion defining a diffuser portion volume, a recombination portion arranged to receive fluid from the diffuser portion during fluid flow in the forward direction through the housing, the recombination portion defining a recombination portion volume, and an outlet portion arranged to receive fluid from the recombination portion during fluid flow in the forward direction through the gas separation device, the outlet portion defining an outlet portion volume. The gas separation device is configured to exhibit an air trapping effectiveness ratio (ATER) that is between 0.001 mL⁻¹ and 0.51 mL⁻¹ during fluid flow in the forward direction through the housing.

In a second example (“Example 2”), the device of Example 1 includes where the gas separation device is configured to exhibit a transition volume that is less than or equal to 5 times the value of the fluid flow path volume during fluid flow in the forward direction through the housing.

In a third example (“Example 3”), the device of Example 1 includes where the gas separation device further includes one fluid flow path exiting the outlet.

In a fourth example (“Example 4”), the device of Example 1 further includes the gas separation device further includes a manifold in fluid communication with the outlet, the manifold dividing fluid exiting the outlet into a plurality of fluid flow paths.

In a fifth example (“Example 5”), the device of Example 4 includes where the plurality of fluid flow paths includes at least two fluid paths.

In a sixth example (“Example 6”), the device of Example 1 includes where the inlet portion volume and the diffuser portion volume together are between 10% to 75% of the fluid path volume.

In a seventh example (“Example 7”), the device of Example 1 includes where a first average fluid velocity used to determine the ATER is defined by a velocity of fluid flowing through the inlet and a second average fluid velocity used to determine the ATER is defined by a velocity of fluid flowing through the diffuser portion.

In an eight example (“Example 8”), the device of Example 7 further includes where the ATER is defined by the ratio of the second average fluid velocity to the first average fluid velocity divided by the diffuser portion volume.

In a ninth example (“Example 9”), the device of Example 1 further includes where at least one of the inner surface and the outer surface at the diffuser portion defines a generally domed longitudinal profile.

In a tenth example (“Example 10”), the device of Example 1 further includes where at least one of the inner surface and the outer surface at the diffuser portion defines a generally flat longitudinal profile.

In an eleventh example (“Example 11”), the device of Example 1 further includes where at least one of the inner surface and the outer surface at the diffuser portion defines a conical or frustoconical profile.

In a twelfth example (“Example 12”), the device of Example 1 further includes where at least a portion of the housing is translucent or transparent such that a gas volume in the diffuser portion is able to be viewed through the housing.

In a thirteenth example (“Example 13”), the device of Example 1 further includes where the recombination portion is defined by a plurality of discrete channels extending between the inner surface and the outer surface of the fluid flow path.

In a fourteenth example (“Example 14”), the device of Example 1 further includes where the recombination portion is defined by an annular channel extending between the inner surface and the outer surface of the fluid flow path.

In a fifteenth example (“Example 15”), the device of Example 1 further includes where the recombination portion is defined by the inner surface and the outer surface of the fluid flow path having a concentric configuration.

In a sixteenth example (“Example 16”), a fluid system includes a gas separation device having a housing defining a fluid flow path between an outer surface and an inner surface, the housing having an inlet in communication with the fluid flow path and an outlet in communication with the fluid flow path, the housing being operable to permit fluid flow in a forward direction from the inlet to the outlet and in a reverse direction, and the fluid flow path defining a fluid path volume. The system further includes a fluid source coupled to the inlet of the gas separation device and at least one chromatography device including an inlet coupled to the outlet of the gas separation device, the fluid source configured to deliver a forward flow through the gas separation device and the chromatography device and the chromatography device operable to permit a reverse flow through the chromatography device, and where the gas separation device is configured to exhibit an air trapping effectives ratio (ATER) that is between 0.001 mL⁻¹ and 0.51 mL⁻¹ during forward flow through the housing.

In a seventeenth example (“Example 17”), the system of Example 16 further includes a first average fluid velocity used to determine the ATER is defined by a velocity of fluid flowing through the inlet and a second average fluid velocity used to determine the ATER is defined by a velocity of fluid flowing through the diffuser portion, and where the ATER is defined by the ratio of the second average fluid velocity to the first average fluid velocity divided by the diffuser portion volume.

In an eighteenth example (“Example 18”), the system of Example 16 further includes where the chromatography device comprises a total volume defined by volume between a fluid inlet of the chromatography device and a fluid outlet of the chromatography device, and where the fluid flow volume of the gas separation device is less than or equal to 50% of the total volume of the chromatography device.

In a nineteenth example (“Example 19”), the system of Example 16 includes where the gas separation device is configured to exhibit a transition volume that is less than or equal to 5 times the value of the fluid flow path volume of the gas separation device during forward flow through the housing.

In a twentieth example (“Example 20”), the system of Example 16 includes where the gas separation device further includes a manifold in fluid communication with the at least one outlet, the manifold dividing fluid exiting the outlet into a plurality of fluid flow paths.

In a twenty-first example (“Example 21”), the system of Example 16 includes where the fluid flow path includes an inlet portion arranged to receive fluid from the inlet during forward flow through the housing, a diffuser portion arranged to receive fluid from the inlet portion during forward flow through the housing, the diffuser portion defining a diffuser portion volume, a recombination portion arranged to receive fluid from the diffuser portion during forward flow through the housing, and an outlet portion arranged to receive fluid from the recombination portion during forward flow through the gas separation device.

In a twenty-second example (“Example 22”), the system of Example 21 includes where at least a portion of one or both of the inner surface and the outer surface of the fluid flow path defining the diffuser portion is translucent or transparent such that a gas bubble may be observed within the diffuser portion.

In a twenty-third example (“Example 23”), a method for trapping and releasing a volume of gas bubbles within a gas separation device, the gas separation device having a housing defining a fluid flow path having an outer surface and an inner surface, the housing having an inlet in fluid communication with the fluid flow path and an outlet in fluid communication with the fluid flow path, the method including delivering a fluid through the flow path in a forward direction such that the fluid flows through the gas separation device from the inlet to the outlet. The method further includes trapping the volume of the gas within the gas separation device where at least a portion of at least one of the inner surface and the outer surface of the housing is translucent such that the volume of gas can be observed and stopping the delivery of the fluid through the fluid flow path. The method further includes delivering the fluid through the fluid flow path in a reverse direction such that fluid flows from the outlet to the inlet to remove at least a portion of the volume of the gas bubbles from the gas separation device.

In a twenty-fourth Example (“Example 24”), the method of Example 23 further includes where the fluid flow path includes an inlet portion arranged to receive fluid from the inlet during fluid flow in the forward direction through the housing, a diffuser portion arranged to receive fluid from the inlet portion during forward flow through the housing, the diffuser portion defining a diffuser portion volume, a recombination portion arranged to receive fluid from the diffuser portion during forward flow through the housing, and an outlet portion arranged to receive fluid from the recombination portion during forward flow through the gas separation device.

In a twenty-fifth example (“Example 25”), the method of Example 24 further includes where trapping the volume of gas bubbles includes trapping the volume of gas bubbles within the diffuser portion of the gas separation device.

In a twenty-sixth example (“Example 26”), the method of Example 23 further includes where the step of reversing the flow occurs once a volume of the gas bubbles approaches a maximum gas bubble volume defined by approximately 95% of the diffuser portion volume.

In a twenty-seventh example (“Example 27”), the method of Example 23 further includes where after the portion of the volume of the gas bubbles has exited the gas separation device, the method further includes delivering fluid through the fluid flow path in the forward direction from the inlet to the outlet of the housing.

In a twenty-eighth example (“Example 28”), the method of Example 23 further includes where the gas separation device exhibits an air trapping effectiveness ratio (ATER) that is between 0.001 mL⁻¹ and 0.51 mL⁻¹ during forward flow through the housing.

In a twenty-ninth example (“Example 29”), the method of Example 23 further includes where the gas separation device exhibits a transition volume that is less than or equal to 5 times the value of the fluid flow path volume during forward flow through the housing.

In a thirtieth example (“Example 30”), the method of Example 24 further includes where the volume of the gas bubbles is between 1% and 100% of the fluid flow path volume.

In a thirty-first example (“Example 31”), the method of Example 23 further includes where the outlet of the gas separation device fluidly couples to an inlet of a chromatography device such that the gas separation device and the chromatography device are arranged in series, and where the method further includes delivering the fluid through the outlet of the gas separation device and into the inlet of a chromatography device.

In a thirty-second example (“Example 32”), a gas separation device includes an outer housing, an inlet coupled with the outer housing, an inner component arranged within the outer housing and defining a diffuser surface and a core, the diffuser surface having a generally domed longitudinal profile, a collector arranged below the inner component, and a plurality of outlets fluidly coupled with the collector. The gas separation device includes a fluid flow path defined by the inlet, a spacing between the inner component and the outer housing, the collector, and the plurality of outlets, and where a portion of the outer housing arranged laterally aligned with and vertically above the diffuser surface is translucent or transparent.

In a thirty-third example (“Example 33”), the device of Example 32 further includes where at least a portion of the core has an annular cross section.

In a thirty-fourth example (“Example 34”), the device of Example 32 further includes where at least a portion of the core has a rectangular cross section.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a flow diagram of a chromatography system, in accordance with some embodiments;

FIG. 2 illustrates a chromatography column in use with a gas separation device, in accordance with some embodiments;

FIG. 3A illustrates a side view of a plurality of chromatography columns in use with a gas separation device, in accordance with some embodiments;

FIG. 3B illustrates a side view of a plurality of chromatography columns in use with a plurality of gas separation devices, in accordance with some embodiments;

FIG. 4 illustrates an enlarged view of the gas separation device of FIG. 2, in accordance with some embodiments;

FIG. 5 illustrates an exploded view of the gas separation device of FIG. 4, in accordance with some embodiments;

FIG. 6 illustrates a cross-sectional view of the gas separation device of FIG. 4, in accordance with some embodiments;

FIG. 7 illustrates a cross-sectional view of a flow profile of the gas separation device of FIG. 4, in accordance with some embodiments;

FIGS. 8A-8F illustrate schematic illustrations of a gas separation device as gas bubbles are delivered through the gas separation device, in accordance with some embodiments;

FIGS. 9A-9F illustrate schematic illustrations of a gas separation device as gas bubbles are delivered through the gas separation device, in accordance with some embodiments;

FIGS. 10A-10F illustrate cross-sectional views of a flow profile of a gas separation device, in accordance with some embodiments;

FIG. 11 illustrates an expected transition curve for varying designs of a gas separation device described with reference to Example 1 in accordance with some embodiments;

FIG. 12 illustrates a step function representing the introduction of a salt solution into a gas separation device in accordance with some embodiments;

FIG. 13 shows an expected transition curve at an outlet of the gas separation device after introduction of the salt solution as shown in FIG. 12 in accordance with some embodiments;

FIGS. 14A-14W illustrate cross-sectional views of 23 designs of a gas separation device as described with reference to Example 1 in accordance with some embodiments;

FIGS. 15A-15C illustrate schematic illustrations of a gas separation device after introduction of gas bubbles as described with reference to Example 2 in accordance with some embodiments; and

FIG. 16 illustrates transition chromatograms associated with the data in Table 2 of Example 2 in accordance with some embodiments.

### DETAILED DESCRIPTION

Persons skilled in the art will readily appreciate that various aspects of the present disclosure can be realized by any number of methods and apparatus configured to perform the intended functions. It should also be noted that the accompanying figures referred to herein are not necessarily drawn to scale but may be exaggerated to illustrate various aspects of the present disclosure, and in that regard, the figures should not be construed as limiting. It is to be understood that, as used herein, the term “on” is meant to denote an element, such as a polymer membrane, is directly on another element or intervening elements may also be present.

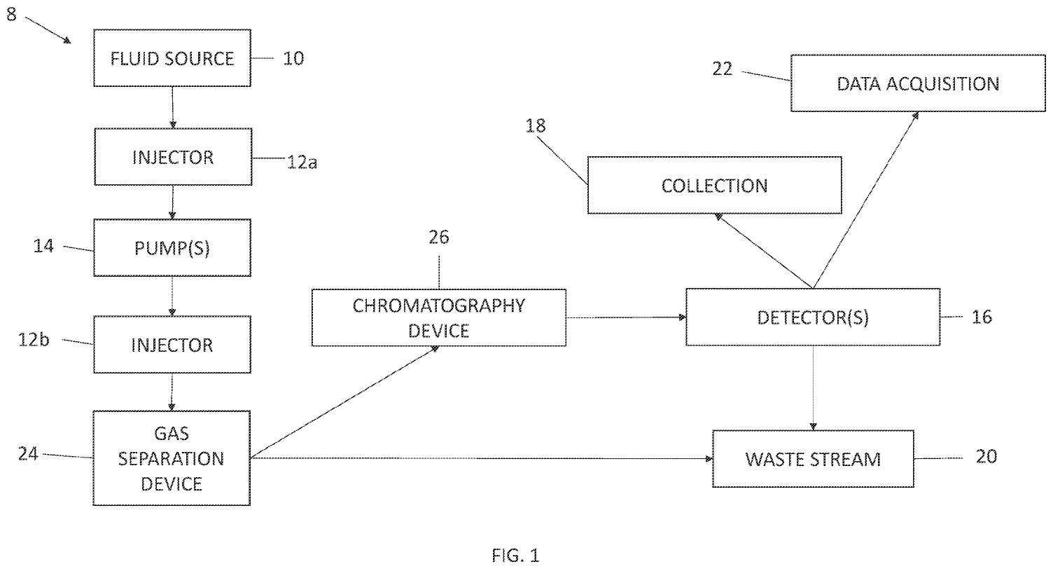

FIG. 1 illustrates a flow diagram of a liquid chromatography system 8, in accordance with some embodiments. The liquid chromatography system 8 may be an affinity chromatography system for separation of a molecule from a liquid. However, various other types of chromatography and associated systems may be utilized with the gas removal concepts described herein including, but not limited to, column chromatography, ion-exchange chromatography, die-ligand chromatography, adsorption columns, and gas chromatography. As shown, the liquid chromatography system 8 includes a fluid source 10, a first injector 12a and a second injector 12b, at least one pump 14, at least one detector 16, a collection 18, a waste stream 20, a data acquisition device 22, a gas separation device 24 and at least one chromatography device 26.

As illustrated, the fluid source 10 is configured for delivering a fluid mixture into the first injector 12a and subsequently into the pump(s) 14. In some embodiments, the first injector 12a is configured to inject analytes and/or other molecules into a liquid delivered from the fluid source 10. The first injector 12a may inject these analytes and/or other molecules into the liquid prior to passage of the liquid from the fluid source 10 into the pump(s) 14. Further, in some embodiments, the second injector 12b is configured for injecting analytes and/or other molecules into the fluid mixture after the fluid mixture has exited the pump(s) 14. In some embodiments, the liquid chromatography system 8 includes both the first injector 12a and the second injector 12b, while in other embodiments, the liquid chromatography system 8 may only include one of the first injector 12a and the second injector 12b.

Further, the pump(s) 14 is configured to pressurize the liquid chromatography system 8 and aid in delivering the fluid mixture from the fluid source 10 through the liquid chromatography system 8 in the desired direction through the liquid chromatography system 8 (whether forward or reverse flow through the liquid chromatography system 8, for example). In some embodiments, the liquid chromatography system 8 may include one pump 14, while in other embodiments, the liquid chromatography system 8 includes two or more pumps. As shown, the gas separation device 24 is fluidly coupled with the second injector 12b and the chromatography device 26. During operation of the liquid chromatography system 8, the fluid mixture is delivered through the gas separation device 24 and into the chromatography device 26 or the waste stream 20. As will be further described below, the gas separation device 24 assists in removing unwanted gas from the fluid mixture flow through the liquid chromatography system 8. The chromatography device 26 separates targeted analytes or molecules from the fluid mixture.

After passage through the chromatography device 26, the fluid mixture is delivered to the detector 16, which is configured for analyzing the separated targeted analytes and/or other molecules of the fluid mixture, the fluid mixture can be collected into a single collection container 18 or a plurality of collection containers (not illustrated) using the single collection container 18 or a plurality of collection containers (not illustrated), while by-products or fluids of the solution that are not the target molecules may be delivered to the waste stream 20 from the detector 16. In the embodiment shown in FIG. 1, the liquid chromatography system 8 includes one detector 16, however in some embodiments, the liquid chromatography system 8 may include at least one detector(s) 16. After passage through the detector(s) 16, in some embodiments, information acquired from the detector(s) 16 based on the characteristics of the fluid mixture may be sent to the data acquisition device 22. The data acquisition device 22 may be used for storing and analyzing the characteristics of the mixture passing through the chromatography device 26.

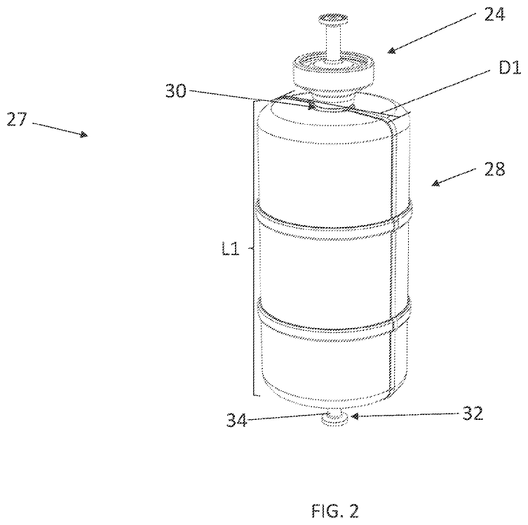

FIG. 2 illustrates an example of a chromatography apparatus 27 that may be used in conjunction with a chromatography device 26 in the liquid chromatography system 8. As illustrated, a housing 28 encloses a chromatography device 26 (not illustrated) having an inlet portion 30 and an outlet portion 32 which extend from the housing 28. The inlet portion 30 is positioned on a side opposite the outlet portion 32. Chromatography devices, such as chromatography device(s) 26, define, or is able to contain, a total volume. Total volume is defined by a volume (also described as an internal volume, or a fluid volume) between the inlet portion 30 and the outlet tube 34 of a chromatography device, such as chromatography device 26 (not illustrated). More specifically, this volume includes both a functional bed volume of the chromatography device defined as the volume that may house, or maintain the fluid during the separation process, and the volume of any channels, tubing, or other connectors associated with the chromatography device.

Though the chromatography device 26 discussed herein and its features are provided by way of example, in some embodiments, the chromatography device 26 of the liquid chromatography system 8 may take on various other configurations based on the desired function and target process being used. In some embodiments, the chromatography device 26 is similar to the chromatography device described in PCT/US21/049969 titled “AFFINITY CHROMATOGRAPHY DEVICES CONTAINING A FIBRILLATED POLYMER MEMBRANE AND MANIFOLDS CONTAINING THE SAME,” to Clinger, et al. Regardless, the chromatography device 26 may include an inlet tube at the inlet portion 30. An outlet tube 34 may extend from the outlet portion 32 and be fluidly connected thereto. While the liquid chromatography system 8 and FIG. 2 are depicted as including only one chromatography device 26, in some embodiments, a plurality of chromatography devices, such as chromatography devices 26, may be incorporated. For example, two or more chromatography devices may be incorporated, each having similar or differing configurations as desired. The chromatography devices, including chromatography device(s) 26, may be coupled together at their inlets by a distributer, or manifold, that is, in turn, coupled with the gas separation device 24. In other words, the gas separation device 24 may service one or multiple of chromatography devices. As such, while referred to herein as a singular chromatography device, such as chromatography device 26, in some embodiments, this may refer to a plurality of chromatography devices, such as chromatography devices 26, coupled together at their inlets.

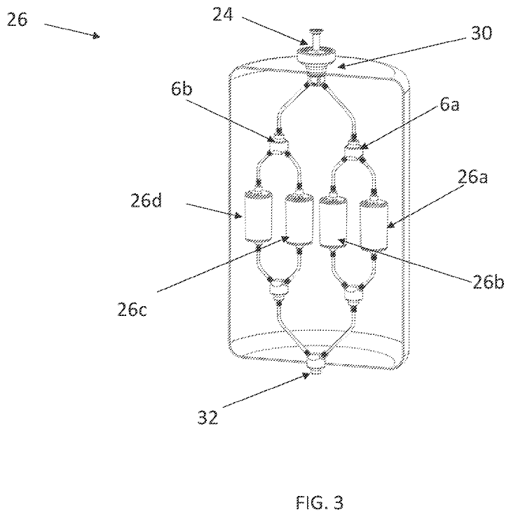

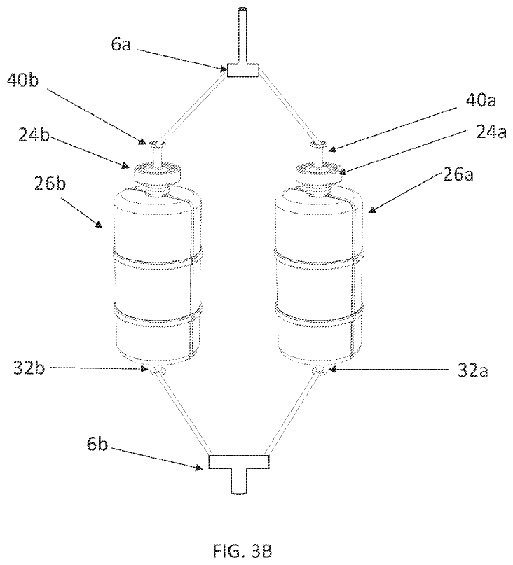

FIG. 3A illustrates such a variation of the chromatography device 26, where the chromatography device 26 includes at least four chromatography devices within a housing 28 and fluidly coupled with the gas separation device 24. More specifically, as illustrated, the chromatography device 26 includes a first manifold 6a connected to a first chromatography device 26a and a second chromatography device 26b, and a second manifold 6b connected to a third chromatography device 26c and a fourth chromatography device 26d. The manifolds 6 may thus be arranged in parallel. The ability to utilize at least two manifolds in parallel advantageously allows for an increase in volume capacity while utilizing the chromatography devices described herein. In other words, the configuration of having a plurality of chromatography devices 26a-d eliminates the need to move to a chromatography device that is larger in volume. In addition, placing the manifolds in parallel, such as is depicted in FIG. 3A, reduces concerns of over pressurizing the chromatography devices 26. In further embodiments, the liquid chromatography system 8 may incorporate four or even more chromatography devices.

Further, in some embodiments, the liquid chromatography system 8 may incorporate more than one chromatography device 26 in combination with more than one gas separation device 24. For example, FIG. 3B illustrates an additional embodiment of a portion of the liquid chromatography system 8 (FIG. 1) where the chromatography device 26 includes the first chromatography device 26a and the second chronography device 26b arranged in parallel. Each of the first and the second chromatography devices 26a, 26b are coupled with a gas separation device. Illustratively, the first chromatography device 26a is fluidly coupled with a first gas separation device 24a and the second chromatography device 26b is fluidly coupled with a second gas separation device 24b. Further, an inlet tube 40a of the first gas separation device 24a and an inlet tube 40b and of the second gas separation device 24b are each coupled to the first manifold 6a such that fluid may be delivered through the manifold 6a from the fluid source 10 (FIG. 1) and delivered into the gas separation devices 24a, 24b and the chromatography devices 26a, 26b in parallel. Similarly, an outlet portion 32a of the first chromatography device 26a and an outlet portion 32b of the second chromatography device 26b may be fluidly coupled with the second manifold 6b such that the fluid joins together into a single fluid path after it is delivered through the chromatography devices 26a, 26b. While illustrated with two gas separation devices, any number of gas separation devices may be incorporated. For example, the liquid chromatography system 8 may include three or more gas separation devices and three or more chromatography devices for attachment with the gas separation devices.

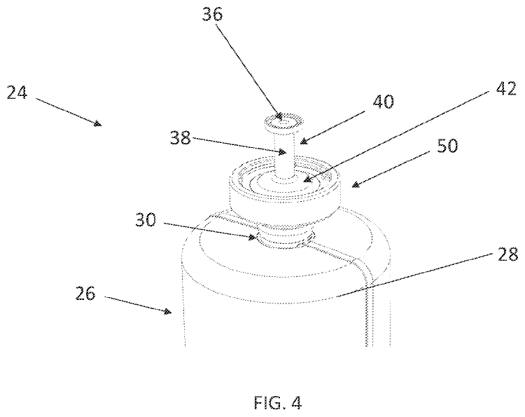

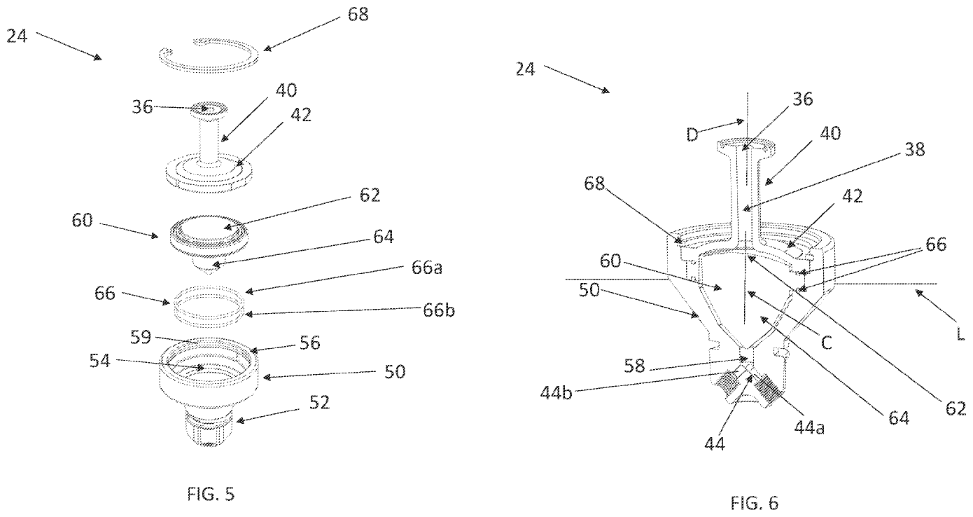

FIG. 4 illustrates an enlarged view of the gas separation device 24 coupled with the inlet portion 30 of the chromatography device (not shown) within the chromatography apparatus 27. The gas separation device 24 includes an inlet tube 40 coupled with an outer housing 50. As will be described further with reference to FIGS. 4-6, the inlet tube 40 and the outer housing 50 are configured for receiving a fluid that then extends through the outer housing 50 and through at least one outlet 44 (FIG. 4). After passage through the at least one outlet 44, the fluid may be delivered into the chromatography device 26. More specifically, the at least one outlet 44 is coupled with the inlet portion 30 of the chromatography device 26 such that the gas separation device 24 and the chromatography device 26 are coupled in series with one another. More specifically, the at least one outlet 44 may be fluidly coupled with a channel and/or tubing that fluidly couples with the inlet tube (not shown) of the chromatography device 26. In some embodiments, the at least one outlet 44 may fluidly couple with a channel that fluidly couples with a manifold, such as manifold 6A (FIG. 3A) to distribute the fluid to a plurality of chromatography devices 26. Further, in other embodiments, the at least one outlet 44 may be directly coupled with a fitting and the inlet tube of the chromatography device 26. The passage of fluid through gas separation device 24 will be described further herein with reference to FIGS. 5 and 6.

FIG. 5 illustrates an exploded view of the gas separation device 24. As illustrated, the gas separation device 24 includes the inlet tube 40 coupled with a top portion 42, an outer housing 50, an inner component 60 for reception within the outer housing 50, a plurality of seals 66, and a connector ring 68 for use in assembling the gas separation device 24. The inlet tube 40 includes an opening 36 that extends into a central portion 38. The central portion 38 couples with a top portion 42 which may define a portion of the outer housing 50 of gas separation device 24. The inlet tube 40 may be defined as generally cylindrical such that the inlet tube 40 includes a circular cross section. However, various other configurations may be implemented and are all considered to be within the purview of this disclosure. Further, the top portion 42 may be defined by a circular, or disc shape as is shown in the illustrative embodiment of FIG. 5, however, various other configurations may be implemented. For example, in some embodiments, the inlet tube 40 and/or the top portion 42 may have a rectangular shape, triangular shape, or any other applicable configuration. Further, the inlet tube 40 and the top portion 42 may be composed of a transparent or a translucent material. For example, the inlet tube 40 and/or the top portion 42 may be composed of a transparent or translucent polymer, such as cyclic olefin copolymer (COC) or an acrylic polymer. However, various other applicable transparent or translucent materials may be used for forming the inlet tube 40 and/or the top portion 42. Transparent may be defined herein as allowing light to pass directly through the material. Translucent may be defined herein as only allowing a portion of light that is directed onto the material to be passed through the material. In some embodiments, inlet tube 40 may not be transparent or translucent while top portion 42 is either transparent or translucent. In other embodiments, only a portion of top portion 42 is transparent or translucent. Regardless of whether transparent or translucent, as will be described further herein, the material of inlet tube 40 and/or top portion 42 is chosen such that gas bubbles positioned vertically below top portion 42 may be visually observed from an exterior of gas separation device 24 (e.g., with the naked eye under natural or artificial lighting).

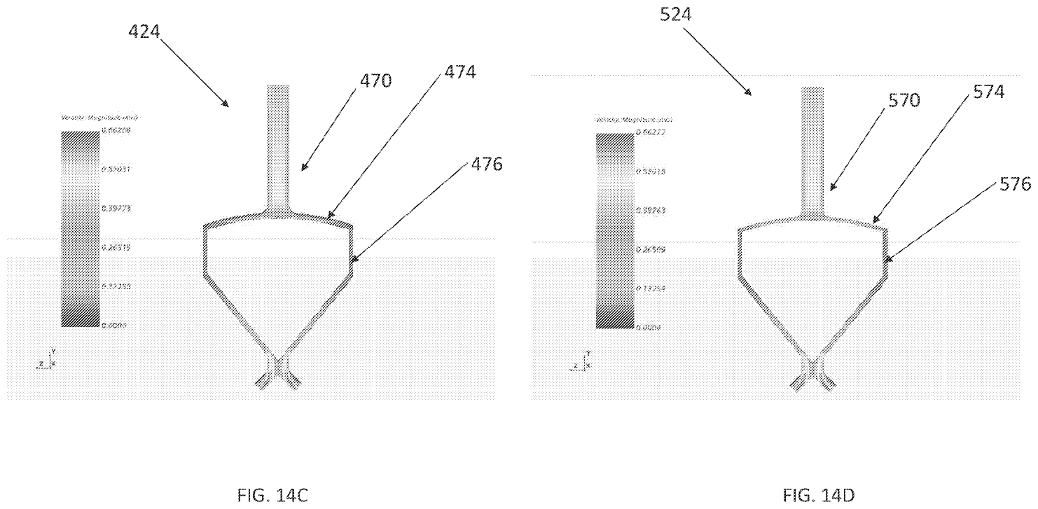

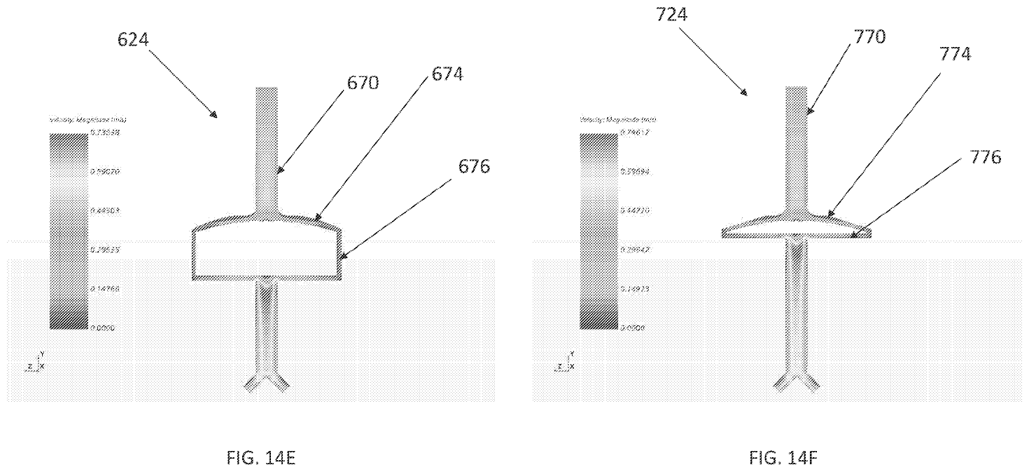

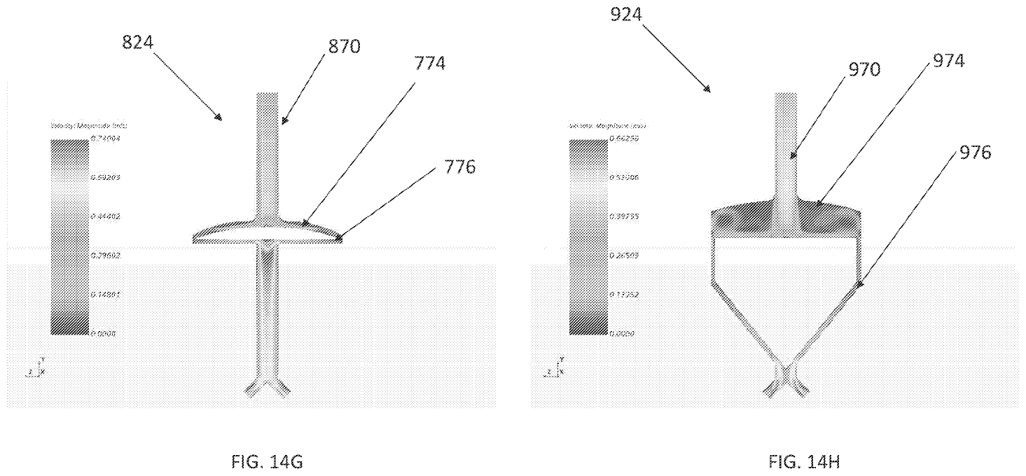

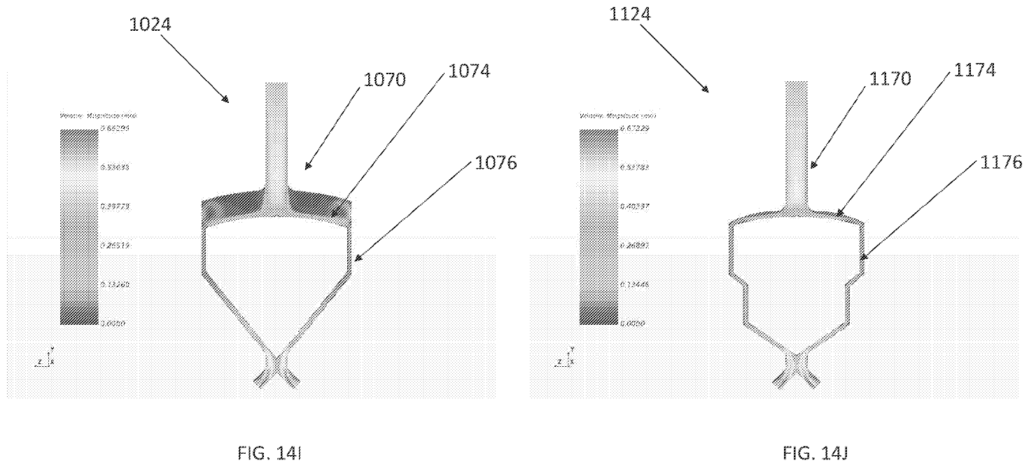

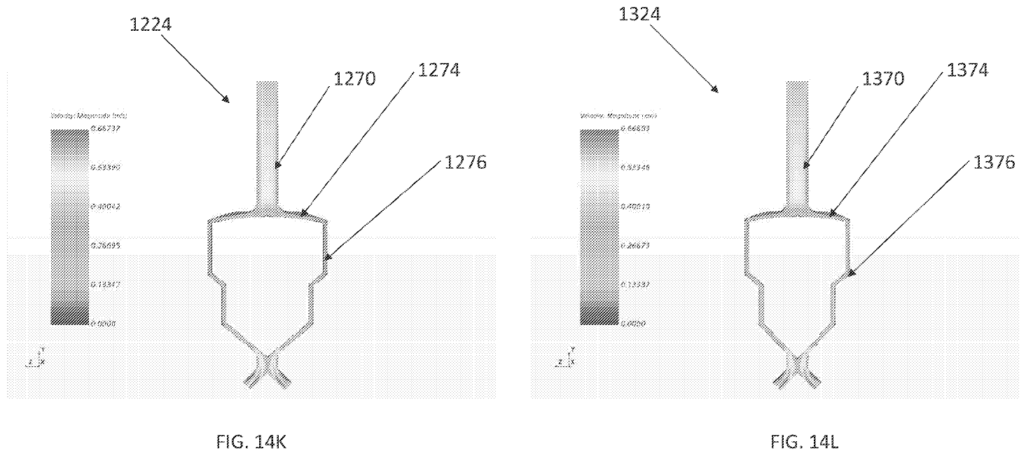

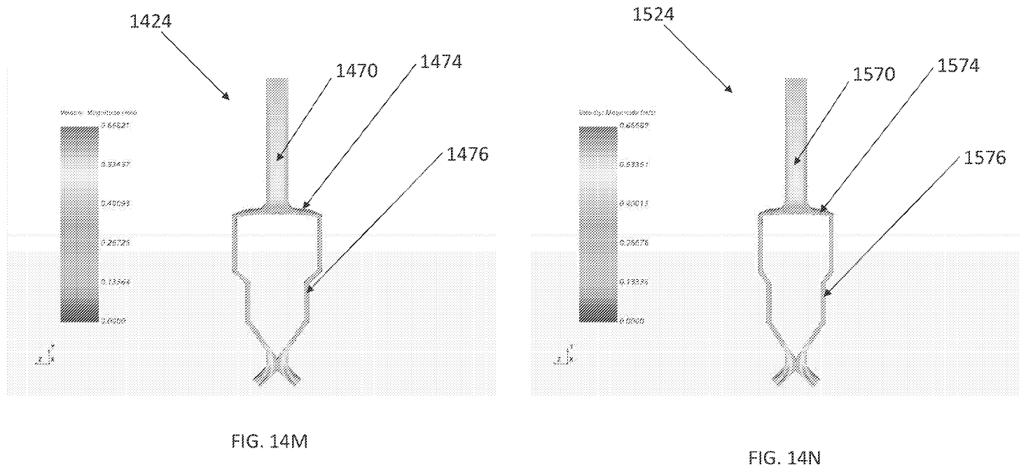

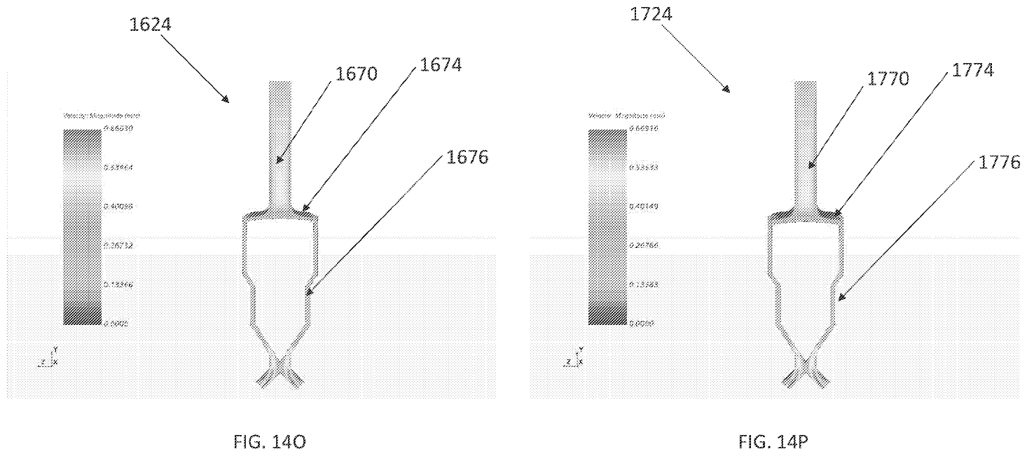

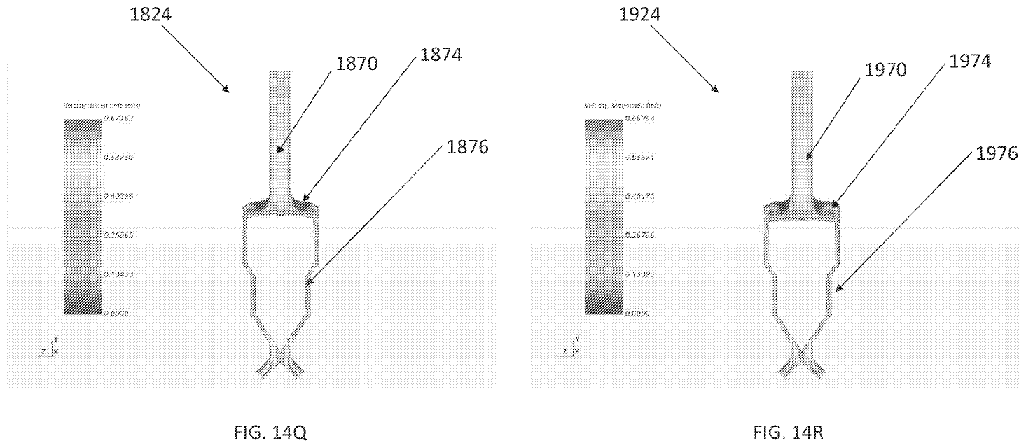

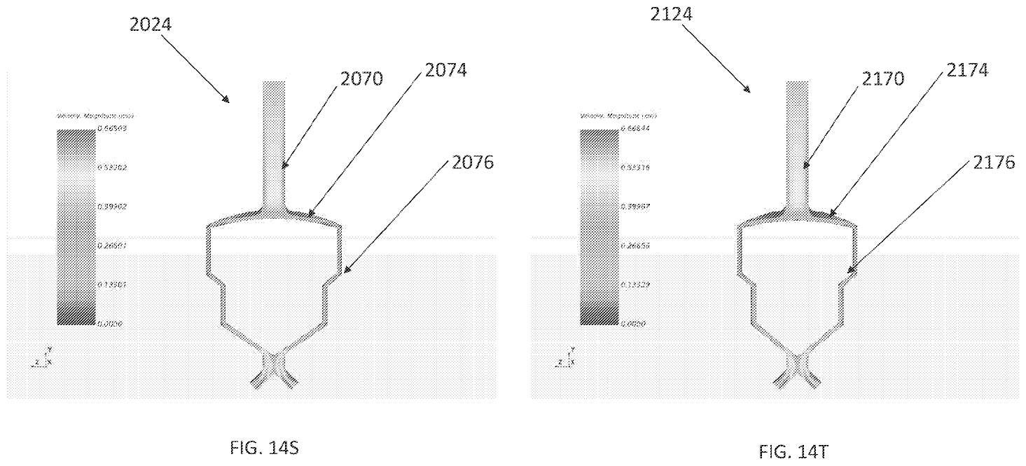

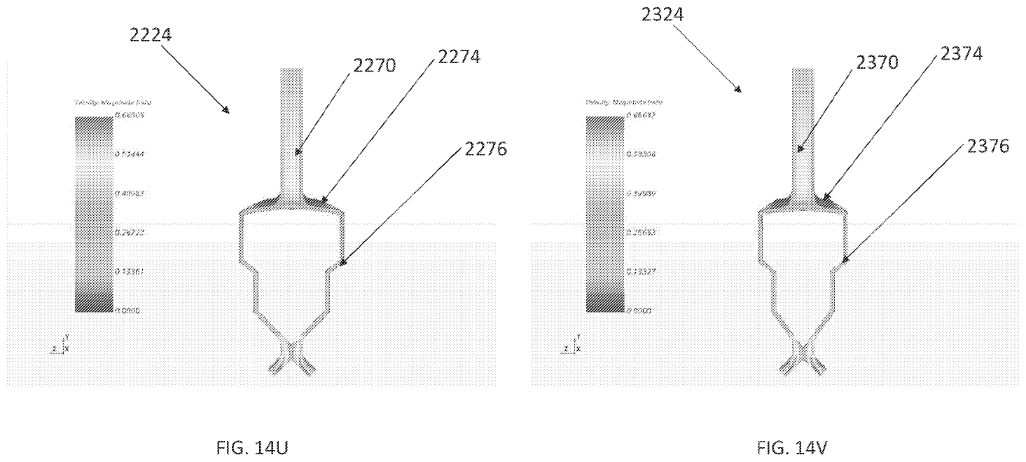

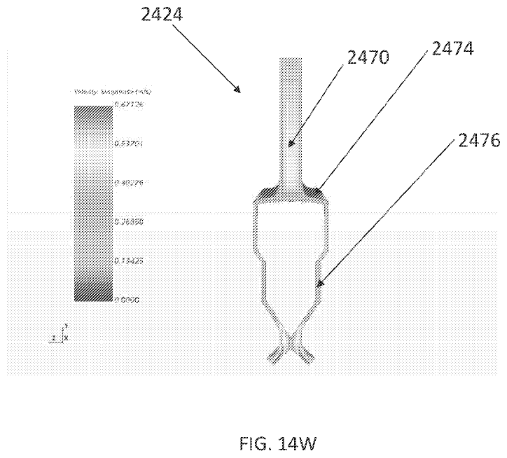

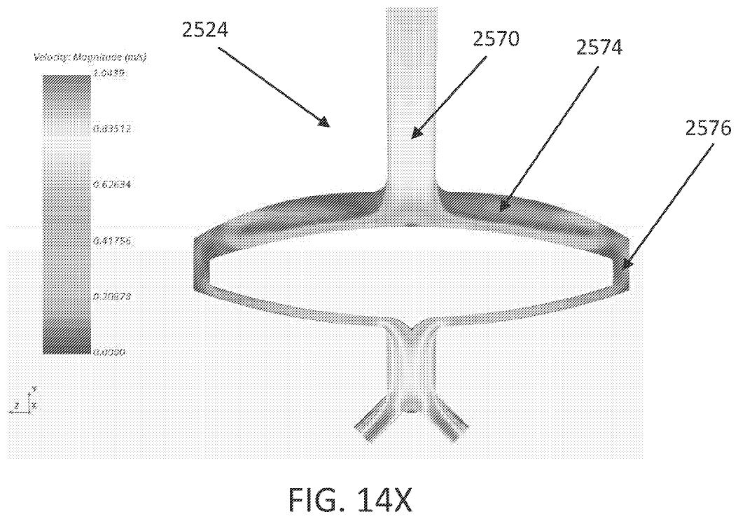

With continued reference to FIG. 5, the inner component 60 will be described further. The inner component 60 includes a top surface 62, also referred to herein as a diffuser surface, and a core 64 extending below the top surface 62. As illustrated best in the cross-sectional view of FIG. 6, the top surface 62 may include a longitudinal profile extending along the longitudinal axis L having a generally domed profile. Generally domed profile may be defined herein as the top surface 62 having a domed or curved shape where the top surface 62 has a maximum vertical height arranged generally within a longitudinal center of the top surface 62, and where the vertical height of the top surface 62 decreases as the top surface 62 extends outward from the longitudinal center. In other embodiments, for example as is shown in a modified gas separation device 924 of FIG. 14H, the top surface 62 may have a generally flat/planar longitudinal profile. In other words, the top surface 62 may have a vertical height that is approximately constant across a width and longitudinal extent of the top surface 62. Further, various other longitudinal profiles may be incorporated, for example a frustoconical and/or conical longitudinal profile may be implemented. However, regardless of the profile of top surface 62 and as shown in FIGS. 5 and 6, the top surface 62 of inner component 60 extends to a vertical height that is less than a lower most vertical height of central portion 38 of inlet tube 40. This is beneficial such that when fluid may be delivered through gas separation device 24 in a reverse direction, the fluid will exit the inlet tube 40 rather than get trapped above the top surface 62 and adjacent the inlet tube 40. Further, the core 64 may define a generally annular cross-sectional shape. However, various other configurations may be implemented. For example, the core 64 may be defined by a rectangular, triangular, oval, polygonal, or irregular shape. The above examples are not meant to be limited and any applicable shape of the core 64 may be incorporated into the gas separation device. Further, in some embodiments, part of the core 64 may have a first cross-sectional shape and another part of the core 64 may have a second cross-sectional shape that differs from the first cross-sectional shape. In further embodiments, the core 64 may include three or more cross-sectional shapes.

With reference still to FIG. 5, the outer housing 50 of the gas separation device 24 will be described further. The outer housing 50 includes the base 52, a cavity 54 extending within the base 52 and bordered by an outer wall 56, and the at least one outlet 44 extending from a bottom portion of the base 52. Illustratively, the outer wall 56 includes a plurality of grooves 59 that extend circumferentially within the outer wall 56 of the base 52 for receiving the plurality of seals 66 and the connector ring 68. The outer housing 50 may be composed of a polymeric material, for example polypropylene, polyether ether ketone (PEEK), cyclic olefin copolymer, polycarbonate, or any other suitable polymeric material. In other embodiments, the outer housing 50 may be composed of a metallic material, or various other applicable materials. The base 52 has a generally circular cross-section, however, various other shapes may be implemented into the base 52. Further, as illustrated, the plurality of seals 66 includes a first seal 66a and a second seal 66b for reception within the grooves 59 of the outer wall 56. In some embodiments, the plurality of seals 66 are O-ring seals, however various other types of seals may be implemented. Additionally, the connector ring 68 is illustrated as having a generally C-shape, however various other configurations and/or shapes of connector ring 68 may be incorporated and are considered within the scope of this disclosure.

With reference to the cross-sectional view of FIG. 6, the assembled gas separation device 24 will be described further herein. As illustrated, the inlet tube 40 is illustrated having the top portion 42 coupled with the base 52 of outer housing 50. More specifically, the top portion 42 is coupled within the grooves 59 of the walls 56 of the outer housing 50. As illustrated, the generally domed profile of the top portion 42 may match the generally domed profile of the top surface 62 of the inner component 60 to create a spacing extending between the top portion 42 and the top surface 62. The connector ring 68 is engaged with the base 52 and positioned above the top portion 42 to secure positioning of the top portion 42 within base 52. The plurality of seals 66, illustratively O-ring seals, may be used during assembly of the gas separation device 24 to ensure a fluid tight seal within the gas separation device 24. Specifically, seals 66 may contribute to the fluid tight seal between inner component 60, top surface 62, and base 52. Further, the inner component 60 is positioned within the cavity 54 such that a central axis C of the inner component 60 is aligned with a central axis D of the inlet tube 40. This allows for the inner component 60 to be spaced apart from the outer walls 56 of the base 52 and create a concentric spacing between the inner component 60 and the outer walls 56 of the base 52. As such, the core 64 of the inner component 60 may be defined by an annular shape. In other words, the inner component 60 is centrally located within outer housing 50. However, in other embodiments, the central axis C of the inner component 60 may be laterally offset from the central axis D of the inlet tube 40. In this way, fluid may flow through the spacing between the inner component and an inner surface of the outer housing 50.

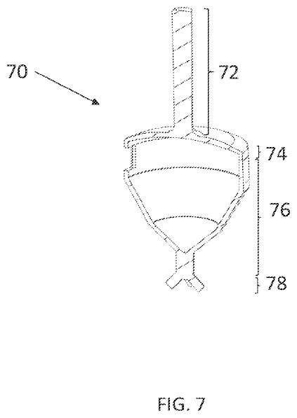

Below the inner component 60, the base 52 includes a collector 58 defined as an area for joining the spacings extending between the inner component 60 and the outer walls 56 of the base 52. Further, extending from the collector 58 is at least one outlet 44, illustratively first and second outlets 44a, 44b, which extend outwardly and may be coupled with the inlet portion of chromatography device 26 (FIG. 3A). While illustrated as two outlets 44a, 44b, the at least one outlet 44 may include one, two, three, four or more outlets. As will be described further with reference to FIG. 6 and FIG. 7, the spacing within inlet tube 40, between the top surface 62 and the top portion 42 and the spacing extending between the inner component 60 and the base 52 defines a fluid flow path for allowing a fluid to pass through the gas separation device 24.

More specifically, and with reference to FIG. 6 and the cross-sectional illustration of the fluid flow profile of the device 24 in FIG. 7, a fluid flow path 70 is formed extending through the gas separation device 24. The fluid flow path 70 includes an inlet portion 72, a diffuser portion 74, a recombination portion 76, and an outlet portion 78. As illustrated, the fluid flow path 70 extends from the opening 36 of the inlet tube 40, down through the central portion 38 of the inlet tube 40 and into the spacing between the top surface 62 and the top portion 42. In this way, the inlet tube 40 defines the inlet portion 72 of the fluid flow path 70 that extends through the inlet tube 40. As the fluid flows through the inlet portion 72 of the fluid flow path 70, fluid defines a first average velocity μ₁.

After extending through the inlet portion 72, the fluid flow path 70 extends into the spacing between the top surface 62 and the outer housing 50. More specifically, fluid extends vertically downward through the inlet portion 72, contacts the top surface 62 of the inner component 60 and diffuses laterally outward along the top surface 62. In this way, the fluid flow path 70 defines a diffuser portion 74 extending vertically between the top surface 62 and the top portion 42 and laterally within the outer housing 50. Within the diffuser portion 74, due to the fluid flow colliding with the top surface 62 and changing flow direction, the velocity of the fluid traveling through the fluid flow path 70 is reduced and defined by a second average velocity μ₂.

Further, as illustrated, the fluid flow path 70 may then extend downward through the spacing between the core 64 of the inner component 60 and the outer walls 56 of the base 52 of the outer housing 50. In this way, the fluid being delivered through the fluid flow path 70 is dispersed into a plurality of fluid paths and extends downward to the collector 58. As such, the fluid flow path 70 may define a recombination portion 76 extending between the top surface 62 of the inner component 60 to a bottom portion of the collector 58. In some embodiments, the recombination portion 76 is defined by an annular and continuous spacing extending around the inner component 60. In other embodiments, the recombination portion 76 may be defined by a plurality of discrete channels that extend around the core 64 of the inner component 60.

Due to the concentric configuration of the inner component 60 and the base 52 of the outer housing 50, any of the fluid paths that may be traveled by the fluid around inner component 60 has the same distance from the top surface 62 and the collector 58. This allows for the fluid flow to maintain plug flow through the fluid flow path 70 and ensure that fluid molecules that were previously grouped together before contacting the top surface 62 rejoin at the collector 58. In other words, the configuration of the inner component 60 allows for a fluid flow that reduces the amount of mixing within a fluid and/or between fluids.

As illustrated, once fluid passes through the collector 58, fluid may extend into the at least one outlet 44 to exit the gas separation device 24. As such, the fluid flow path 70 defines the outlet portion 78 extending vertically between the bottom of the collector 58 and out of the gas separation device 24.

Each of the above-described portions of the fluid flow path 70 is defined by a fluid path volume, which may also be referred to herein as a hold up volume of the gas separation device 24. In other words, the fluid flow path volume and the hold-up volume are both measured as the fluid flow volume that may extend through the gas separation device 24, which is the sum of the volumes of the above-described portions of the fluid flow path 70. For example, inlet portion 72 includes an inlet portion volume defined by the volume of inlet portion 72 capable of holding the fluid. Further, the amount of space defined between top surface 62 and top portion 42 defines a diffuser volume of the diffuser portion 74. Similarly, a volume of the spacing between the top surface 62 and the bottom of collector 58 defines a recombination portion volume. Lastly, the volume of the at least one outlet 44, illustratively the sum of the volumes of the outlet 44a and the outlet 44b, defines an outlet portion volume. As previously described, the fluid flow path volume is defined by the sum of each of the inlet portion volume, the diffuser portion volume, the recombination portion volume, and the outlet portion volume. In some embodiments, the inlet portion volume and the diffuser portion volume together are between 10% to 75% of the fluid path volume. Further, the inlet portion volume and the diffuser portion volume together may be between 35% and 50% of the fluid path volume. However, various other volume ratios between the various portions of fluid flow path 70 may be incorporated. For example, the outlet portion volume may be between 5%-75% of the fluid path volume. In further embodiments, the outlet portion volume may be between 10% and 50% of the fluid path volume.

As will be described further with reference to the test methods and examples, the gas separation device 24 is configured such that if there is a volume of gas bubbles contained within fluid delivered through the fluid flow path 70 in a forward direction, as fluid passes through the diffuser portion 74, the volume of gas bubbles will be trapped within the diffuser portion 74 and between the top surface 62 and the top portion 42. The forward direction is defined as the fluid extending from the inlet portion 72 to the outlet portion 78. As fluid flows through the fluid flow path 70 in this direction, any volume of gas bubbles will continue to be trapped within the diffuser portion 74. An operator may actuate the liquid chromatography system 8 to reverse the fluid flow through the gas separation device 24 and the chromatography device 26. More specifically, an operator may interact with a user interface that is leveraged to send commands to the components of the liquid chromatography system 8 (FIG. 1) in order to actuate the liquid chromatography system 8 to stop the flow of fluid through gas separation device 24 in the forward direction and subsequently reverse the flow of the fluid through the gas separation device 24 such that fluid is delivered through the gas separation device 24 from the outlet portion 78 to the inlet portion 72. The reversed flow through the fluid flow path 70 causes at least a portion of the volume of gas bubbles to exit through the inlet tube 40 of the gas separation device 24. Reversal of the fluid thus causes at least a portion of the volume of gas bubbles trapped within the diffuser portion 74 to exit with fluid through the inlet tube 40. In this operation state, the fluid is delivered from the gas separation device 24 into the waste stream 20 to ensure that gas bubbles leave the liquid chromatography system 8 and are not reintroduced to the gas separation device 24.

Since at least the top portion 42 is either transparent or translucent, the operator may visualize the volume of the gas bubbles trapped within the diffuser portion 74 and visualize the removal of the volume of the gas bubbles from the diffuser portion 74. In this way, the operator may monitor the gas separation device 24 to stop and reverse the flow when a desired volume of the gas bubbles is visualized trapped within the gas separation device 24. For example, in some embodiments, an operator may monitor the gas separation device 24 and stop the flow once the volume of gas bubbles reaches a maximum volume of gas bubbles, which may be defined as at least 95% of the volume of the diffuser portion 74. Additionally, fluid may be delivered in reverse flow for a varying amount of time controlled by the operator. For example, fluid flow may be reversed until between at least 1% and 100% of the volume of trapped gas is removed from the diffuser portion 74. In some embodiments, fluid flow is operated in reverse until at least 25% of the volume of gas bubbles is removed from the diffuser portion 74.

The operator may subsequently stop the flow of the fluid and actuate the fluid to flow into the forward direction once again. When this occurs, the inlet tube 40 is connected again with a fluid source, for example the fluid source 10 (FIG. 1), and the outlets 44 are coupled with the inlet portion (not shown) of the chromatography device 26 to deliver the fluid through the gas separation device 24 and into the chromatography device 26.

As described above, the gas separation device 24 provides the advantage of being able to efficiently capture gas bubbles within the gas separation device 24 and easily reverse the fluid flow in order to remove the trapped gas bubbles from within the gas separation device 24. As will be described further with reference to the test methods and examples, the ability of the gas separation device 24 to capture gas bubbles may be quantified through an air trapping effectiveness ratio (ATER). The ATER is calculated by dividing the ratio of the second average velocity μ₂ to the first average velocity μ₁ by the diffuser portion volume. The gas separation device 24 is configured such that the ATER ranges from between approximately 0.001 mL⁻¹ to approximately 0.51 mL⁻¹ while the fluid flows through the gas separation device 24 in the forward direction. When the ATER is maintained within the above recited range, the gas separation device 24 is able to capture gas bubbles from the fluid passing through fluid flow path 70, trap the gas bubbles within diffuser portion 74, and release the gas bubbles upon reverse flow of the fluid through the fluid flow path 70.

An additional advantage of the gas separation device 24 is the reduction of a transition volume of the fluid delivered through the gas separation device 24 and/or the chromatography device 26. More specifically, when a first fluid is inserted through the gas separation device 24 and a second fluid is subsequently delivered into the gas separation device 24, the transition volume is the volume through which the two fluids flow until the first fluid is no longer detected. As will be described further with reference to test methods and examples, the gas separation device 24 may exhibit a transition volume with a value approximately equal to or less than five times the value of the fluid path volume of the gas separation device 24. In some embodiments, the transition volume may be less than or equal to five times the value of the fluid path volume. Further, when calculated with reference to the transition volume for the flow through both the gas separation device 24 and the chromatography device 26, the transition volume may be equal to or less than five times the total volume of the gas separation device 24 and the chromatography device 26. A further advantage of the gas separation device 24 is that the device 24 is configured such that the fluid flow volume of the gas separation device 24 is less than or equal to 50% of the total volume of the chromatography device 26. For example, in some embodiments, the fluid flow volume of the gas separation device 24 may be between approximately 1% and 50% of the total volume of the chromatography device 26. However, various other ratios of the fluid flow volume of the gas separation device 24 to the chromatography device 26 may be implemented.

Persons skilled in the art will readily appreciate that various aspects of the present disclosure can be realized by any number of methods and apparatus configured to perform the intended functions. It should also be noted that the accompanying figures referred to herein are not necessarily drawn to scale but may be exaggerated to illustrate various aspects of the present disclosure, and in that regard, the figures should not be construed as limiting.

### Test Methods

### Method for Simulating Liquid Flow Through Devices

A computational fluid dynamics (CFD) model was developed in a commercial solver. The fluid flow solver is based on the finite volume method where the flow domain is divided into smaller volumes, also called cells, and the governing equations are solved at the centroid of each cell. The governing equations will be presented and discussed further herein. The flow fluid velocity in the three directions, the fluid pressure, salt concentration, as well as turbulence variables at each cell is computed from solving the governing equations. As previously described, FIG. 6 illustrates a cross-sectional view of the gas separation device 24 that contains the fluid path modeled with the computational fluid dynamics (CFD), while FIG. 7 illustrates a cross-sectional view of the gas separation device 24 with a schematic fluid domain of the gas separation device 24. As test methods herein may be described with reference to the gas separation device 24, other embodiments of the gas separation device 24 are simulated using computational fluid dynamics.

The fluid flow field was computed by solving the Reynolds-averaged Navier Stokes equations which includes conservation of mass and momentum. The Shear-Stress-Transport k-omega model was used to predict the fluid turbulence through the fluid flow path.

The conservation of mass and momentum equations are shown as follows:

$$\frac{\partial ρ}{\partial t} + ∇ \cdot ( ρ \overline{v} ) = 0$$

### Conservation of Mass Equation

$$\frac{\partial }{\partial t} ( ρ \overline{v} ) + ∇ \cdot ( ρ \overline{v} ⊗ \overline{v} ) = - ∇ \cdot \overline{p} I + ∇ \cdot ( T + {T}_{RANS} ) + {f}_{b}$$

### Momentum Equation

where ρ is the density, v is the mean velocity, p is the mean pressure, I is the identity tensor, T is the mean viscous stress tensor, f_{b} is the resultant of the body forces (such as gravity), and T_{RANS} is the stress tensor.

A constant mass flow rate was defined at the inlet portion 72 of the gas separation device 24 (FIGS. 6-7). The outlet was fixed at zero-gauge pressure. The incompressible assumption was considered for liquid and ideal gas for air. The properties used for the methods include water and air properties for liquid and gas phases, respectively. The density of the liquid was set at 997.561 kg/m3 and the viscosity at 8.8871 Pa-s. The interfacial surface force is modeled as a volumetric force using the continuum surface force (CSF) approach of Brackbill and others (Brackbill, J. U., Kothe, D. B., and Zemach, C. 1992. A Continuum method for modeling surface tension, J. Comp. Physics, 100, pp. 335-354.) The surface tension constant between liquid and gas was fixed 0.072 N/m. However, various other surface tensions and density values may be used to model desired fluid and material properties.

Method for Simulating Behavior of an Air Bubble through Devices and Determining Air Trapping Effectiveness Parameter in Simulation

The volume of fluid (VOF) multiphase model is used to predict the air and liquid interface inside the gas separation device 24. The distribution of phases (air and liquid) and the position of the interface are described by the field of phase volume fraction αᵢ, the fraction of which is shown below. Vᵢ is the volume of phase i in the cell and V is the volume of cell.

$${a}_{i} = \frac{{V}_{i}}{V}$$

The volume fraction of all phases in a cell must sum up to one, dictated by the below formula, where N is the total number of phases.

$${\sum }_{i = 1}^{N} {a}_{i} = 1$$

The fluids that are present in the same interface-containing cell are treated as a mixture with volume averaged properties.

The results from simulating liquid flow through devices are used as an initial condition of the bubble simulation. Initially, there is only water passing through the gas separation device 24 at a fixed flow rate. Next, a fixed volume of gas bubble is injected at the inlet portion 72 of the gas separation device 24.

The bubbles are trapped by volume expansion in the simulated gas separation device 24. Such expansion will affect fluid flow properties such as velocity, pressure drop, residence time, mixing, drag forces, and surface tension forces.

In order to predict the performance of a design, the following parameter is introduced:

$$Air Trapping Effectiveness Ratio = \frac{\frac{{u}_{2}}{{u}_{1}}}{V}$$

where u₂ is the averaged fluid velocity inside the diffuser portion 74, u₁ is the averaged fluid velocity of the inlet portion 72, and V is the volume of the diffuser portion 74.

The gas bubble trapping performance is decreased by increasing the Air Trapping Effectiveness Ratio (ATER). The gas bubbles will pass through the gas separation device 24 if the ATER is higher than a critical number. The ATER can be decreased by increasing the volume of the diffuser portion 74. However, the bubble capture performance is not affected by decreasing the ATER below the critical number.

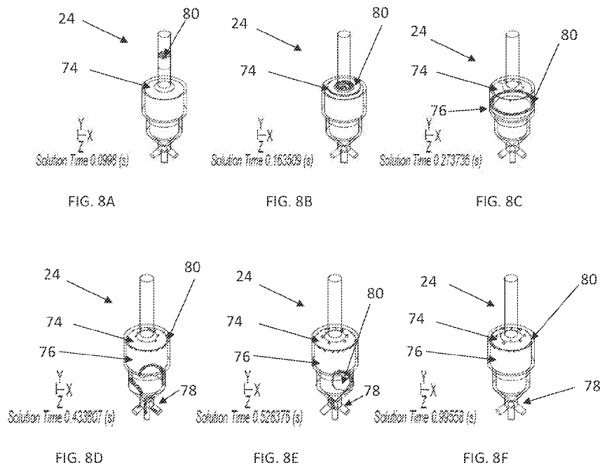

For example, FIGS. 8A-8F illustrate the gas separation device 24, or a slight variation thereof, simulated as having an ATER of approximately 0.938 mL⁻¹ and over a simulated time status. As illustrated in FIGS. 8A-8F, while the fluid flows through the fluid flow path 70 of the gas separation device 24 and gas bubbles 80 are delivered into the system, the gas bubbles 80 travel through the entirety of the gas separation device 24 and are not trapped within the diffuser portion 74 of the gas separation device 24. Specifically, FIG. 8A illustrates the simulation at a simulated time point of approximately 0.1 seconds after delivery of the gas bubbles 80 into the inlet portion 72. FIG. 8B illustrates the simulation within the gas separation device 24 at a time point of approximately 0.2 seconds after the delivery of the gas bubbles 80 into the inlet portion 72. As shown illustratively in FIGS. 8A-8F, the gas bubbles 80 are positioned within the diffuser portion 74. Further, FIG. 8C illustrates the simulation at a time point of approximately 0.3 seconds after the delivery of the gas bubbles 80. As illustrated the gas bubbles have passed through the diffuser portion 74 and moved to the recombination portion 76. FIG. 8D and FIG. 8E illustrate the gas bubbles 80 positioned within the diffuser portion 74, recombination portion 76, and the outlet portion 78 of the gas separation device 24. FIG. 8F illustrates the system at a time point of approximately 0.1 seconds after the delivery of the gas bubbles 80 into the inlet portion 72, at which point the gas bubbles 80 have passed through the entirety of the gas separation device 24. As such, FIGS. 8A-8F illustrate how the gas bubbles 80 are not trapped just in the diffuser portion 74 but instead pass through the entirety of the gas separation device 24.

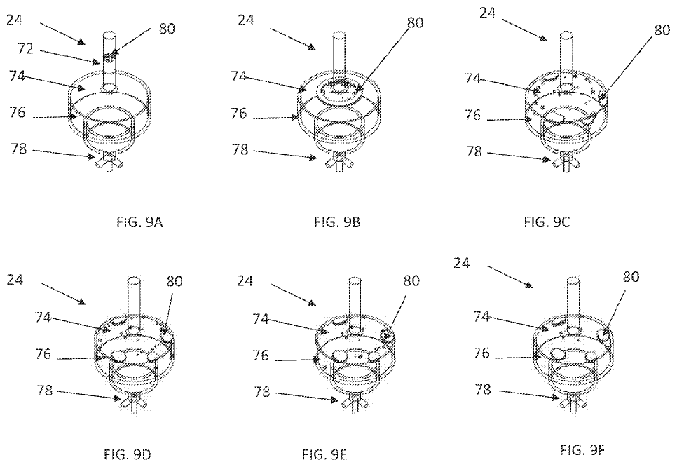

FIGS. 9A-9F illustrate the method of the simulation with the gas separation device 24, simulated as having an ATER of approximately 0.116 mL⁻¹. As illustrated, gas bubbles 80 are delivered with fluid into the gas separation device 24 and are trapped within the diffuser portion 74. Specifically, in FIG. 9B, the fluid and the gas bubbles 80 are illustrated extending into diffuser portion 74. While fluid continuously flows through gas separation device 24, in FIGS. 9C-9F, the gas bubbles 80 are illustrated remaining trapped in a diffuser portion 74 and do not extend lower into the gas separation device 24. This is desired for proper function of the gas separation device 24, so that gas bubbles 80 are not delivered into the chromatography device 26 (FIG. 2).

### Method for Simulating a Salt Solution Flow Transition Through Devices

Salt was introduced as a tracer in the flow field and its movement inside the gas separation device 24 was tracked by solving the convection-diffusion equation:

$$\frac{\partial c}{\partial t} + u \cdot ∇ c = {D}_{ij} {∇}^{2} c$$

In the above equation, c, u and Dᵢⱼ, are the salt concentration, fluid velocity, and salt diffusivities in the fluid, respectively. The model formulation above assumes that the fluid properties do not change due to the salt. The salt was introduced at the inlet boundary as a step function.

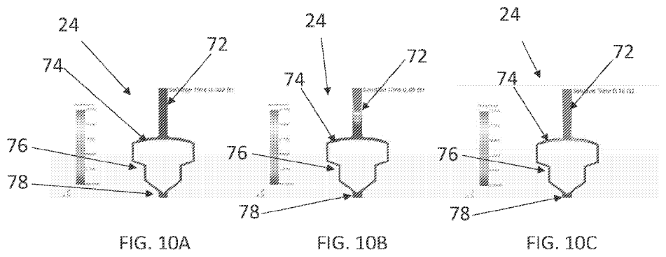

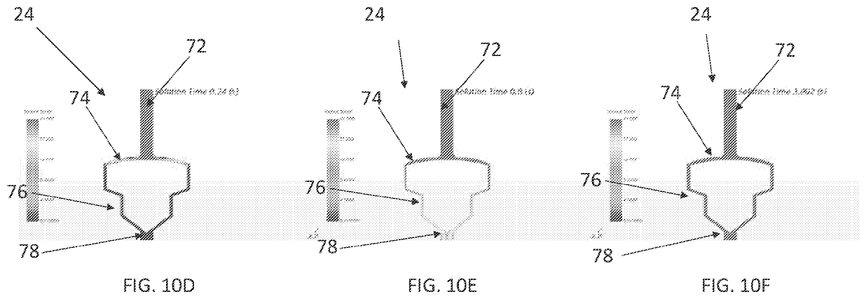

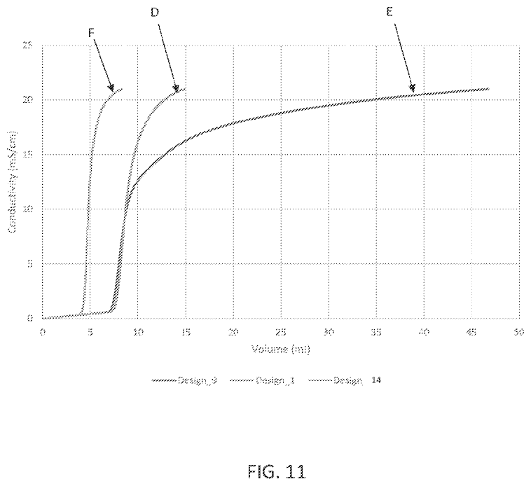

FIGS. 10A-10F illustrate the CFD model of the gas separation device 24 as the salt solution inserted through the fluid flow path 70 is modeled. Specifically, FIG. 10A illustrates the gas separation device 24 prior to the insertion of the salt solution. FIG. 10B illustrates the CFD model of the gas separation device 24 as salt solution is inserted into the inlet portion 72 of the gas separation device 24. Further, FIGS. 10C-10D illustrate the salt solution inserted further through the fluid flow path 70 of the gas separation device 24, illustrating the mixing of the fluids as well. As illustrated in FIGS. 10E and 10F, over time and continued insertion of the salt solution, the mixing reduces and the fluid flow path 70 is fully consumed with the salt solution.

This method may be applied with several different designs of the device through changing the parameters incorporated into the model. Further, the model allows for a transition curve to be determined, as shown in FIG. 11.

Specifically, FIG. 11 shows the expected transition curve for three varying designs of the gas separation device 24. More specifically, design 1 corresponds to the gas separation device 24 as shown in FIG. 14A and has a transition curve D, design 9 corresponds to a modified gas separation device 1024 as shown in FIG. 14I exhibiting a transition curve E, and design 14 corresponds to a modified gas separation device 1524 of FIG. 14N, which corresponds to a transition curve F. The transition curve illustrates the conductivity of the solution versus the volume of solution flowing through, to illustrate the transition volume for each design. As illustrated, the simulated gas separation devices of designs 1 and 14 achieve the steady state conductivity based in a lesser volume than is required for design 9. The steady state conductivity may be a set conductivity chosen based on the conductivity of the second fluid that is simulated as delivered through the gas separation device 24. This corresponds to a smaller transition volume for the simulated gas separation devices of designs 1 and 14 in comparison to the transition volume of the simulated gas separation device of design 9.

### Method for Determining Volume to Complete a Simulated Salt Solution Flow Transition Through Devices

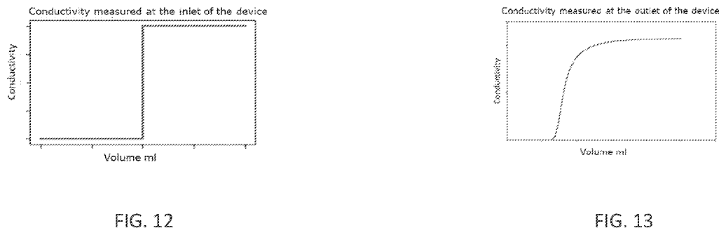

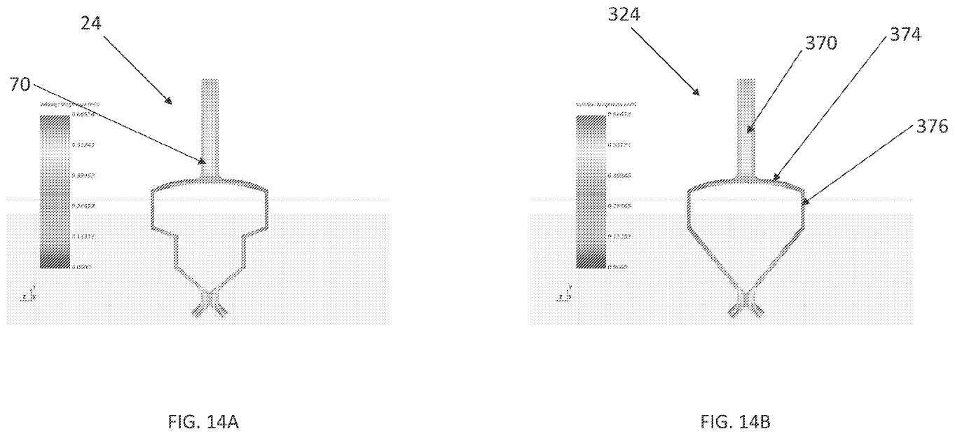

The ATER may be decreased by increasing the fluid path volume of the gas separation device, but it will lead to increase in the transition volume of the gas separation device. High transition volume is not desirable for chromatographic applications. Increasing the transition volume of the device may lead to higher solution consumptions and lower the efficiency of the process. To measure the transition volume of the gas separation device in practice, a transition test is usually conducted. A transition experiment involves pushing one fluid out of the gas separation device by introducing a new fluid. Therefore, the transition simulation was conducted by introducing the salt solution at the inlet boundary using a step function as shown in FIG. 12. FIG. 13 shows the expected transition curve at the outlet of a simulated gas separation device. The conductivity of the salt solution and water were set at 21.5 and 0.01 mS/cm, respectively. The transition volume was measured when the conductivity at the outlet reached 21 mS/cm, which was determined as the steady state conductivity.

### Method for Experimental Confirmation of Air Trapping Effectiveness

The gas separation device 24 was physically constructed from Design 1 from Table 1 and referred to herein as Gas Separation Device A. Gas Separation Device A, mounted on top of a spiral wound manifolded affinity chromatography device as described in PCT Application No. PCT/US21/049969 to Clinger, et al. was placed in an AKTA Pilot liquid chromatography system (Cytiva, Marlborough, MA) and phosphate buffered saline (PBS) was pumped through Gas Separation Device A and the spiral wound manifolded affinity chromatography device at a flowrate of 696 mL/min. A gas bubble was introduced to Gas Separation Device A by removing the feed tube from the PBS buffer, then the feed tube was placed back into the PBS buffer roughly one second after tube removal. A few seconds after the gas bubble was captured in Gas Separation Device A, the liquid chromatography system pumps were reversed, and the gas bubble was evacuated with a small amount of PBS to a waste stream.

### Method for Experimental Confirmation of Transition Volume

An affinity chromatography device 26 described in the PCT Application No. PCT/US21/049969 to Clinger, et al., with or without a Gas Separation Device A mounted on the inlet of the affinity chromatography device, was placed in an AKTA Pilot liquid chromatography system (Cytiva, Marlborough, MA). Phosphate buffered saline (PBS) was pumped through the device at a flowrate of 152 mL/min, followed by deionized water pumped through the device at a flowrate of 152 mL/min. The transition volume was reported as the amount of volume (normalized to column volumes) required to flow through the affinity chromatography device, with and without a Gas Separation Device A mounted on the inlet of the affinity chromatography device, to reach a conductivity at the outlet of the device of 0.15 mS/cm, indicating a full volumetric transition from PBS to water. The column volume is defined as the total volume of the chromatography device 26 (FIG. 2).

### Examples

### Example 1: Results from Simulation with Computational Fluid Dynamics (CFD)

A total of 24 unique, modified designs of the gas separation device 24 (FIG. 3) were generated and flow performance was simulated, using the Test Methods described previously. FIGS. 14A-14X illustrate cross-sectional views of the simulated designs 1-24, respectively. Specifically, FIG. 14A illustrates the cross-sectional view of the gas separation device 24. FIG. 14B illustrates a modified gas separation device 324, having a fluid flow path 370 with a linearly shaped recombination portion 376 such that there is no indent within the recombination portion 376. FIG. 14C illustrates a modified gas separation device 424 defining a fluid flow path 470 with a uniform diffuser portion 474 and a linear recombination portion 476. Further, FIG. 14D illustrates a modified gas separation device 524 with a modified fluid flow path 570 having a thinner diffuser portion 574 such that the volume of the diffuser portion 574 may be less than the volume of the diffuser portion 74 (FIG. 14A). Additionally, FIG. 14E shows a modified gas separation device 624 having a modified fluid flow path 670 with a recombination portion 674 that extends linearly downward and continues into a laterally extending portion. Further, FIG. 14F illustrates a modified gas separation device 724 with a modified fluid flow path 770 having a recombination portion 776 that extends linearly and laterally from the corners joining with a diffuser portion 774 of the gas separation device 724.

With reference to FIG. 14G, a modified gas separation device 824 is illustrated having a similar design as that shown in FIG. 14E. FIG. 14H illustrates an additional modified gas separation device 924 with a modified fluid flow path 970 where a top surface, similar to the top surface 62 (FIG. 1), has a linear and flat profile such that the bottom of the diffuser portion 974 is illustrated as having a flat profile. Further, the volume of the diffuser portion 974 is illustrated as larger than the volume of the diffuser portion 74 of the gas separation device. Further, with reference to FIG. 14I, a modified gas separation device 1024 with a modified fluid flow path 1070 is illustrated. The modified fluid flow path 1070 is similar to that as the fluid flow path 470 of the gas separation device 424, however with a diffuser portion 1074 having a larger volume. With reference to FIG. 14J, a modified gas separation device 1124 with a modified flow profile 1170 is shown, where a diffuser portion 1174 has a diameter that is approximately 90% of a diameter of the diffuser portion 74 of the gas separation device 24. Additionally, FIG. 14K illustrates a modified gas separation device 1224 where a diffuser portion 1274 has a diameter of approximately 80% of the diameter of the diffuser portion 74, FIG. 14L illustrates a modified gas separation device 1324 having a diffuser portion 1374 with a diameter of approximately 70% of the diameter of the diffuser portion 74, and FIG. 14M illustrates a modified gas separation device 1424 having a diffuser portion 1474 with a diameter of approximately 60% of the diameter of the diffuser portion 74. Further, FIG. 14N illustrates a gas separation device 1524 with a diffuser portion 1574 having a diameter of approximately 50% of the diameter of the diffuser portion 74.

FIG. 14O illustrates a modified gas separation device 1624 having a diffuser portion 1674 with a diameter of 50% of the diameter of the diffuser portion 74, along with an increased thickness. FIG. 14P illustrates a modified gas separation device 1724 having a diffusor portion 1774 similar the diffuser portion 1674 (FIG. 14O) with a greater thickness than the thickness of the diffuser portion 1674. Similarly, FIGS. 14Q and 14R illustrate modified gas separation devices 1824, 1924, respectively, with diffuser portions 1874, 1974 having increasing thicknesses. Further, FIGS. 14S and 14T illustrate modified gas separation devices 2024, 2124, respectively, with varying thicknesses and diameters of the respective diffusion portions 2074, 2174. Similarly, FIGS. 14U, 14V, and 14W illustrate additional modified gas separation devices 2224, 2324, and 2424, respectively, which have varying thicknesses and diameters of their respective diffusion portions 2274, 2374, and 2474.

FIG. 14X illustrates a modified gas separation device 2524 with a design similar to FIGS. 14F and 14G, with an overall diameter approximately two times larger, a curved recombination portion 2576, and a larger diffuser portion 2574 compared to FIGS. 14F and 14G.

The simulated delivery of gas bubbles through each of the above-described models was conducted. The simulation results are set forth in Table 1. The results showed that the bubbles passed through the respective gas separation device if the air trapping effectiveness ratio (ATER) was above 0.51 mL⁻¹.

TABLE 1
Simulation Data Summary

| | | | | | | Transition |
|---|---|---|---|---|---|---|
| | | | | | | Volume (number |
| | Diffuser | | | | | of gas separation |
| | Portion | Fluid Path | ATER | Air | Transition | device fluid path |
| Design | volume (ml) | Volume (ml) | (ml⁻¹) | Captured | Volume (ml) | volumes) |
| 1 | 2.51 | 9.61 | 0.116 | Yes | 14.90 | 1.55 |
| 2 | 2.51 | 9.59 | 0.116 | Yes | 14.69 | 1.53 |
| 3 | 2.54 | 9.62 | 0.107 | Yes | 14.62 | 1.52 |
| 4 | 1.58 | 8.68 | 0.229 | Yes | 12.07 | 1.39 |
| 5 | 2.51 | 8.78 | 0.116 | Yes | 14.23 | 1.62 |
| 6 | 1.98 | 6.53 | 0.169 | Yes | 11.15 | 1.71 |
| 7 | 2.51 | 7.07 | 0.116 | Yes | 12.35 | 1.75 |
| 8 | 13.53 | 20.43 | 0.015 | Yes | 54.02 | 2.64 |
| 9 | 11.41 | 18.31 | 0.016 | Yes | 46.80 | 2.56 |
| 10 | 2.01 | 8.98 | 0.159 | Yes | 14.05 | 1.56 |
| 11 | 1.55 | 7.79 | 0.232 | Yes | 12.50 | 1.60 |
| 12 | 1.152 | 6.68 | 0.353 | Yes | 10.97 | 1.64 |
| 13 | 0.824 | 5.67 | 0.562 | No | 9.56 | 1.69 |
| 14 | 0.555 | 4.94 | 0.938 | No | 8.35 | 1.69 |
| 15 | 0.822 | 5.15 | 0.509 | Yes | 9.56 | 1.86 |
| 16 | 1.154 | 5.41 | 0.316 | Yes | 10.97 | 2.03 |
| 17 | 1.542 | 5.7 | 0.217 | Yes | 13.10 | 2.30 |
| 18 | 2.013 | 6.07 | 0.157 | Yes | 15.82 | 2.61 |
| 19 | 2.157 | 9.03 | 0.145 | Yes | 14.55 | 1.61 |
| 20 | 1.98 | 8.05 | 0.166 | Yes | 14.12 | 1.75 |
| 21 | 1.746 | 7.06 | 0.194 | Yes | 13.31 | 1.89 |
| 22 | 1.488 | 6.11 | 0.233 | Yes | 11.79 | 1.93 |
| 23 | 1.242 | 5.42 | 0.291 | Yes | 11.51 | 2.12 |
| 24 | 38.69 | 58.17 | 0.005 | Yes | 204 | 3.51 |

### Example 2: Experimental Confirmation of Air Trapping Effectiveness and Transition Volume

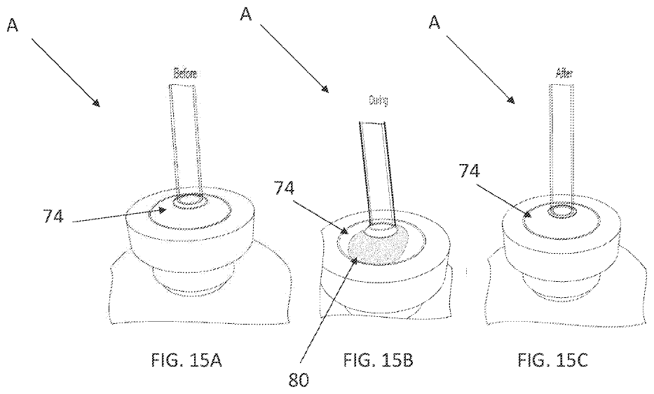

A series of time lapse schematics shown in FIGS. 15A-15C taken from still photographs demonstrated that gas bubbles introduced into Gas Separation Device A are both visualized and removed using the appropriate Test Method(s) described previously. As illustrated in FIG. 15A, before the insertion of the gas bubbles, fluid flows through Gas Separation Device A and no gas bubbles are illustrated as being trapped in the diffuser portion 74. However, during insertion of the gas bubbles 80, gas bubbles 80 are illustrated within diffuser portion 74 (see FIG. 15B) and are observable from an exterior of Gas Separation Device A. Further, after reversal of the fluid flow through Gas Separation Device A, and as shown in FIG. 15C, the gas bubbles are no longer observed within diffuser portion 74 and have been evacuated from Gas Separation Device A.

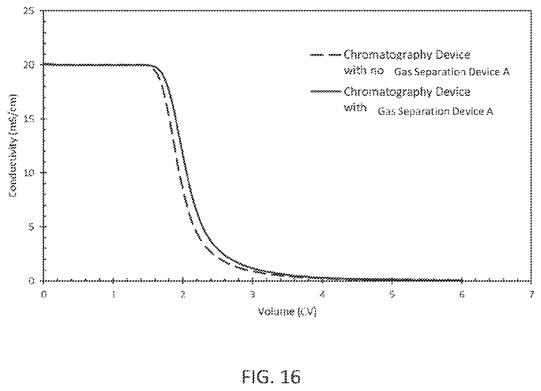

The transition volumes without and with Gas Separation Device A in the chromatography device flow path are reported in Table 2, determined using the Test Method(s) set forth previously. The difference in transition volumes is small, indicating Gas Separation Device A has negligible effect on transition volume. As set forth in Table 2, the transition volume of the system with or without Gas Separation Device A remains below 5 times the column volume. Transition chromatograms associated with the data in Table 2 are shown in FIG. 16.

TABLE 2
Transition Volume

| | Residence | | Transition |
|---|---|---|---|
| | Time | Device | Volume |
| Device ID | (seconds) | size (mL) | (CV) |
| Chromatography | 30 | Chromatography | 4.39 |
| Device with no | | Device Size: | |
| Gas Separation | | 76 mL | |
| Device A | | | |
| Chromatography | 30 | Chromatography | 4.72 |
| Device with Gas | | Device Size: | |
| Separation | | 76 mL | |
| Device A | | Gas Separation | |
| | | Device A Fluid | |
| | | Flow Path | |
| | | Volume: 9 mL | |

Persons skilled in the art will readily appreciate that various aspects of the present disclosure can be realized by any number of methods and apparatus configured to perform the intended functions. It should also be noted that the examples and methods herein should not be construed as limiting.

What is claimed is:

1. A gas separation device, comprising:
a housing defining a fluid flow path between an outer surface and an inner surface, the housing having an inlet in communication with the fluid flow path and an outlet in communication with the fluid flow path, the housing being operable to permit fluid flow in a forward direction from the inlet to the outlet and in a reverse direction from the outlet to the inlet, and the fluid flow path defining a fluid path volume and having:
an inlet portion arranged to receive fluid from the inlet during fluid flow in the forward direction through the housing, the inlet portion defining an inlet portion volume;
a diffuser portion arranged to receive fluid from the inlet portion during fluid flow in the forward direction through the housing, the diffuser portion defining a diffuser portion volume;
a recombination portion arranged to receive fluid from the diffuser portion during fluid flow in the forward direction through the housing, the recombination portion defining a recombination portion volume;
an outlet portion arranged to receive fluid from the recombination portion during fluid flow in the forward direction through the gas separation device, the outlet portion defining an outlet portion volume; and
wherein the gas separation device is configured to exhibit an air trapping effectiveness ratio (ATER) that is between 0.001 mL⁻¹ and 0.51 mL⁻¹ during fluid flow in the forward direction through the housing.

2. The gas separation device of claim 1, wherein the gas separation device is configured to exhibit a transition volume that is less than or equal to 5 times the value of the fluid flow path volume during fluid flow in the forward direction through the housing.

3. The gas separation device of claim 1, wherein the gas separation device further includes one fluid flow path exiting the outlet.

4. The gas separation device of claim 1, wherein the gas separation device further includes a manifold in fluid communication with the outlet, the manifold dividing fluid exiting the outlet into a plurality of fluid flow paths.

5. The gas separation device of claim 4, wherein the plurality of fluid flow paths includes at least two fluid paths.

6. The gas separation device of claim 1, wherein the inlet portion volume and the diffuser portion volume together are between 10% to 75% of the fluid path volume.

7. The gas separation device of claim 1, wherein a first average fluid velocity used to determine the ATER is defined by a velocity of fluid flowing through the inlet and a second average fluid velocity used to determine the ATER is defined by a velocity of fluid flowing through the diffuser portion.

8. The gas separation device of claim 7, wherein the ATER is defined by the ratio of the second average fluid velocity to the first average fluid velocity divided by the diffuser portion volume.

9. The gas separation device of claim 1, wherein at least one of the inner surface and the outer surface at the diffuser portion defines a generally domed longitudinal profile.

10. The gas separation device of claim 1, wherein at least one of the inner surface and the outer surface at the diffuser portion defines a generally flat longitudinal profile.

11. The gas separation device of claim 1, wherein at least one of the inner surface and the outer surface at the diffuser portion defines a conical or frustoconical profile.

12. The gas separation device of claim 1, wherein at least a portion of the housing is translucent or transparent such that a gas volume in the diffuser portion is able to be viewed through the housing.

13. The gas separation device of claim 1, wherein the recombination portion is defined by a plurality of discrete channels extending between the inner surface and the outer surface of the fluid flow path.

14. The gas separation device of claim 1, wherein the recombination portion is defined by an annular channel extending between the inner surface and the outer surface of the fluid flow path.

15. The gas separation device of claim 1, wherein the recombination portion is defined by the inner surface and the outer surface of the fluid flow path having a concentric configuration.

16. A fluid system comprising:
a gas separation device having a housing defining a fluid flow path between an outer surface and an inner surface, the housing having an inlet in communication with the fluid flow path and an outlet in communication with the fluid flow path, the housing being operable to permit fluid flow in a forward direction from the inlet to the outlet and in a reverse direction, and the fluid flow path defining a fluid path volume;
a fluid source coupled to the inlet of the gas separation device; and
at least one chromatography device including an inlet coupled to the outlet of the gas separation device, the fluid source configured to deliver a forward flow through the gas separation device and the chromatography device and the chromatography device operable to permit a reverse flow through the chromatography device; and
wherein the gas separation device is configured to exhibit an air trapping effectiveness ratio (ATER) that is between 0.001 mL⁻¹ and 0.51 mL⁻¹ during forward flow through the housing.

17. The system of claim 16, wherein a first average fluid velocity used to determine the ATER is defined by a velocity of fluid flowing through the inlet and a second average fluid velocity used to determine the ATER is defined by a velocity of fluid flowing through the diffuser portion, and wherein the ATER is defined by the ratio of the second average fluid velocity to the first average fluid velocity divided by the diffuser portion volume.

18. The system of claim 16, wherein the chromatography device comprises a total volume defined by volume between a fluid inlet of the chromatography device and a fluid outlet of the chromatography device, and wherein the fluid flow volume of the gas separation device is less than or equal to 50% of the total volume of the chromatography device.

19. The system of claim 16, wherein the gas separation device is configured to exhibit a transition volume that is less than or equal to 5 times the value of the fluid flow path volume of the gas separation device during forward flow through the housing.

20. The system of claim 16, wherein the gas separation device further includes a manifold in fluid communication with the at least one outlet, the manifold dividing fluid exiting the outlet into a plurality of fluid flow paths.

21. The system of claim 16, wherein the fluid flow path includes an inlet portion arranged to receive fluid from the inlet during forward flow through the housing, a diffuser portion arranged to receive fluid from the inlet portion during forward flow through the housing, the diffuser portion defining a diffuser portion volume, a recombination portion arranged to receive fluid from the diffuser portion during forward flow through the housing, and an outlet portion arranged to receive fluid from the recombination portion during forward flow through the gas separation device.

22. The system of claim 21, wherein at least a portion of one or both of the inner surface and the outer surface of the fluid flow path defining the diffuser portion is translucent or transparent such that a gas bubble may be observed within the diffuser portion.

23. A method for trapping and releasing a volume of gas bubbles within a gas separation device, the gas separation device having a housing defining a fluid flow path having an outer surface and an inner surface, the housing having an inlet in fluid communication with the fluid flow path and an outlet in fluid communication with the fluid flow path, the method comprising:
delivering a fluid through the flow path in a forward direction such that the fluid flows through the gas separation device from the inlet to the outlet;
trapping the volume of the gas within the gas separation device wherein at least a portion of at least one of the inner surface and the outer surface of the housing is translucent such that the volume of gas can be observed;
stopping the delivery of the fluid through the fluid flow path; and
delivering the fluid through the fluid flow path in a reverse direction such that fluid flows from the outlet to the inlet to remove at least a portion of the volume of the gas bubbles from the gas separation device.

24. The method of claim 23, wherein the fluid flow path includes an inlet portion arranged to receive fluid from the inlet during fluid flow in the forward direction through the housing, a diffuser portion arranged to receive fluid from the inlet portion during forward flow through the housing, the diffuser portion defining a diffuser portion volume, a recombination portion arranged to receive fluid from the diffuser portion during forward flow through the housing, and an outlet portion arranged to receive fluid from the recombination portion during forward flow through the gas separation device.

25. The method of claim 24, wherein trapping the volume of gas bubbles includes trapping the volume of gas bubbles within the diffuser portion of the gas separation device.

26. The method of claim 23, wherein the step of reversing the flow occurs once a volume of the gas bubbles approaches a maximum gas bubble volume defined by approximately 95% of the diffuser portion volume.

27. The method of claim 23, wherein after the portion of the volume of the gas bubbles has exited the gas separation device, the method further includes delivering fluid through the fluid flow path in the forward direction from the inlet to the outlet of the housing.

28. The method of claim 23, wherein the gas separation device exhibits an air trapping effectiveness ratio (ATER) that is between 0.001 mL⁻¹ and 0.51 mL⁻¹ during forward flow through the housing.

29. The method of claim 23, wherein the gas separation device exhibits a transition volume that is less than or equal to 5 times the value of the fluid flow path volume during forward flow through the housing.

30. The method of claim 24, wherein the volume of the gas bubbles is between 1% and 100% of the fluid flow path volume.

31. The method of claim 23, wherein the outlet of the gas separation device fluidly couples to an inlet of a chromatography device such that the gas separation device and the chromatography device are arranged in series, and wherein the method further includes delivering the fluid through the outlet of the gas separation device and into the inlet of a chromatography device.

32. A gas separation device, comprising:
an outer housing;
an inlet coupled with the outer housing;
an inner component arranged within the outer housing and defining a diffuser surface and a core, the diffuser surface having a generally domed longitudinal profile; a collector arranged below the inner component;
a plurality of outlets fluidly coupled with the collector;
a fluid flow path defined by the inlet, a spacing between the inner component and the outer housing, the collector, and the plurality of outlets; and
wherein a portion of the outer housing arranged laterally aligned with and vertically above the diffuser surface is translucent or transparent.

33. The gas separation device of claim 32, wherein at least a portion of the core has an annular cross section.

34. The gas separation device of claim 32, wherein at least a portion of the core has a rectangular cross section.
